(19) United States
(12) Patent Application Publication
(10) Pub. No.: US 2008/0184460 A1
(43) Pub. Date: Aug. 7, 2008

(54) POCKET SQAURE/HANDKERCHIEF HOLDER

(76) Inventor: Larry H. Jones, Glendale, AZ (US)

Correspondence Address: NW-IP-LAW, 6039 E. Grant RD., Tucson, AZ, 85712, US

(21) Appl. No.: 12/024,322

(22) Filed: Feb. 1, 2008

Related U.S. Application Data
(60) Provisional application No. 60/887,893, filed on Feb. 2, 2007.

(51) Int. Cl. A41B 15/02; A44B 21/00; B42F 1/00

(52) U.S. Cl. 2/279; 24/3.7; 24/67 R; 24/303

(57) ABSTRACT

The present invention is directed to a pocket square/handkerchief holder including a generally curved elongated holding member, a clasp member, and a clipping device to allow a person to easily display a pocket square/handkerchief in his/her outer breast pocket of a suit, sport or overcoat.

This application claims priority to U.S. Patent Application Ser. No. 60/887,893, the disclosure of which is incorporated in its entirety by reference herein.

### BACKGROUND OF THE INVENTION

The present invention is directed to a pocket square/handkerchief holder including a holding member, a clasp member, a clipping device, and a magnetic member to allow a person to easily hold a pocket square/handkerchief in his/her outer breast pocket. An object of this invention is to provide a pocket square/handkerchief holder that allows a person to place a pocket square/handkerchief in his/her outer breast pocket and keep the pocket square/handkerchief upright within the pocket displaying the desired fold.

### SUMMARY OF THE INVENTION

The present invention provides a pocket square/handkerchief holder having a generally curved elongated holding member, said generally curved elongated holding member comprising a front surface and a back surface, said generally curved elongated holding member fixedly attached to a clipping device, said clipping device fixedly attached to a center portion of said back surface of said generally curved elongated holding member and retains and secures said folded handkerchief against said back surface of said generally curved elongated holding member, said generally curved elongated holding member is placed within a person's shirt or coat pocket to display said folded handkerchief. In some embodiments, the pocket square/handkerchief holder further comprises a magnetic member, said magnetic member is fixedly attached to a top portion of said back surface of said generally curved elongated holding member and releasably attaches to other magnetic members. In some embodiments, the pocket square/handkerchief holder further comprises a clasp member, said clasp member is fixedly attached to a bottom portion of said back surface of said generally curved elongated holding member and holds folded money bills.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is an illustration of a pocket square/handkerchief holder according to the invention including a holding member, a clasp member, a clipping device, and a magnetic member.

FIG. 2 is a back view of the pocket handkerchief holder of FIG. 1.

FIG. 3 is a top view of the pocket handkerchief holder of FIG. 1. FIG. 3B is a top view of the pocket handkerchief holder of FIG. 1 with the clipping device in an open position.

### DESCRIPTION OF PREFERRED EMBODIMENTS

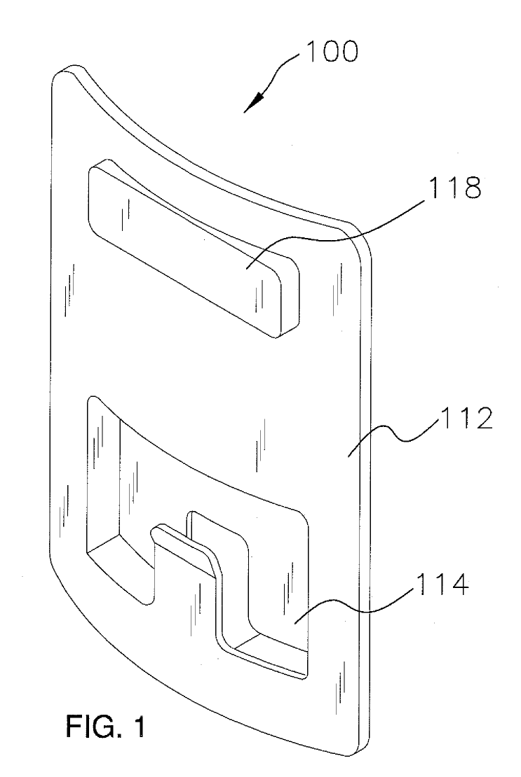

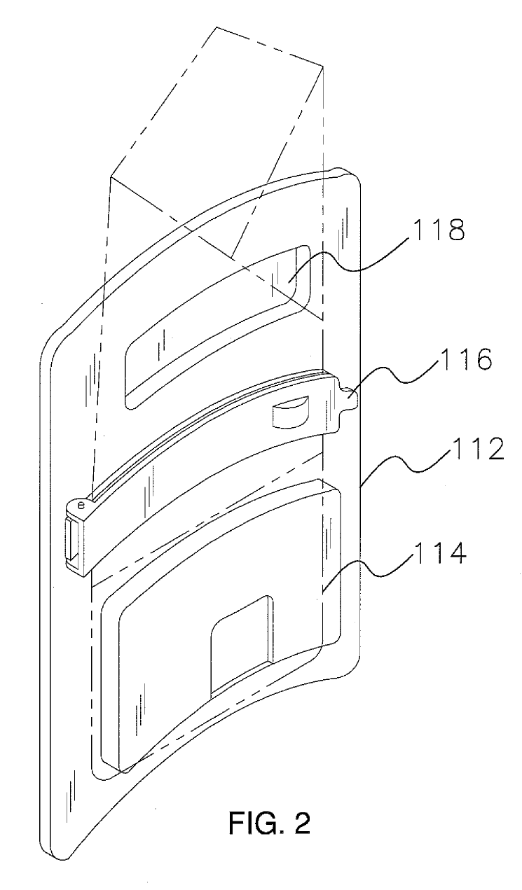

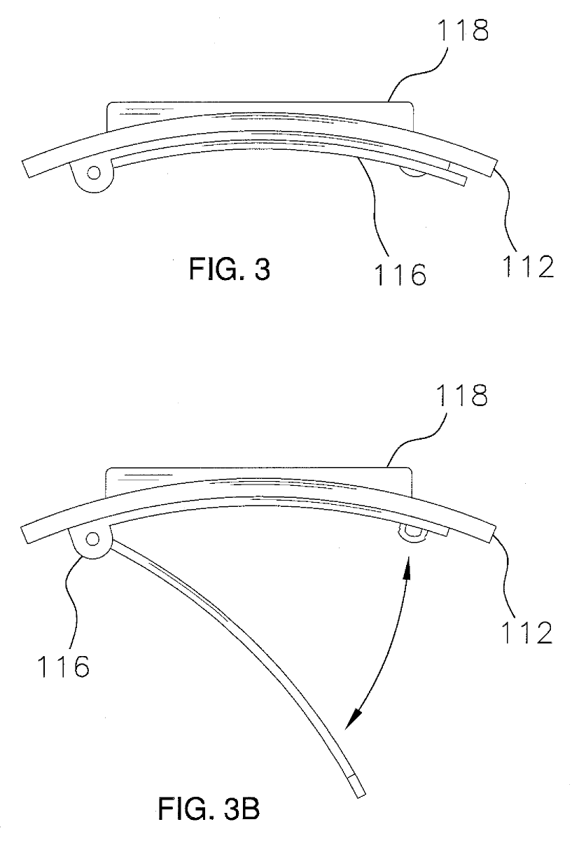

Referring now to FIG. 1, pocket square/handkerchief holder 100 is shown comprising a generally curved elongated holding member 112, clasp member 114, and magnetic member 118. To use the pocket square/handkerchief holder 100, a handkerchief is folded to a desired style. The handkerchief is then placed inside clipping device 116 and clipping device 116 is snapped shut to hold the pocket handkerchief in place (see FIG. 2 and FIG. 3B). Pocket square/handkerchief holder 100 is then placed inside a person's outer breast pocket to be displayed. In certain embodiments, pocket square/handkerchief holder 100 comprises clasp member 114 to hold folded money bills. In certain embodiments, pocket square/handkerchief holder 100 comprises magnetic member 118 to allow a person to attach magnetic name tags or other magnetic promotion items to the outside of a person's shirt or coat pocket when pocket square/handkerchief holder 100 is housed within the shirt or coat pocket. The curvature of holding member 112 allows the handkerchief to stand upright in a person s shirt or coat pocket without the top portion of the handkerchief bending forward or flopping downward. Additionally, the curvature of holding member 112 fits snuggly against a person's chest to keep pocket handkerchief holder 100 from protruding outwardly within a person's shirt or coat pocket.

In certain embodiments, holding member 112 comprises a rigid plastic material. In certain embodiments, holding member 112 is a generally curved elongated member having a length between about 3 inches and about 5.25 inches, for example 4.26 inches. In certain embodiments, holding member 112 comprises a width between about 2 inches and about 4 inches, for example 3.04 inches. In certain embodiments, holding member 112 comprises a curved radius between about 3.5 and about 4.2, for example 3.93. In certain embodiments, clasp member 114 comprises a tabbed slot known to one skilled in the art. In certain embodiments, clasp member 114 comprises a height between about 1 inches and about 2.5 inches, for example 1.25 inches. In certain embodiments, clasp member 114 comprises a width between about 0.75 inches and about 2.75 inches, for example 2 inches. In certain embodiments, clipping device 116 comprises a standard hair barrette. In some embodiments, the barrette has a curvature similar to that of the generally curved elongated holding member 112. In certain embodiments, magnetic member 118 comprises a standard magnet known to one skilled in the art.

Referring now to FIG. 2, a back view of pocket square/handkerchief holder 100 is shown comprising a generally curved elongated holding member 112, clasp member 114, clipping device 116, and magnetic member 118. In the illustrated embodiment of FIG. 2, a handkerchief is folded to a desired style. The handkerchief is then placed inside clipping device 116 and clipping device 116 is snapped shut to hold the pocket square/handkerchief in place. Pocket square/handkerchief holder 100 is then placed inside a person's jacket to be displayed.

Referring now to FIG. 3, a top view of pocket square/handkerchief holder 100 is shown comprising holding member 112, clipping device 116, and magnetic member 118. In the illustrated embodiment of FIG. 3, the curvature of holding member 112 allows the pocket square/handkerchief to stand upright in a person's shirt and/or coat pocket without the top portion of the handkerchief bending forward or flopping downward.

Referring now to FIG. 3B, a top view of pocket square/handkerchief holder 100 is shown with clipping device 116 in an open position. A handkerchief is folded to a desired style. The handkerchief is then placed inside clipping device 116 and clipping device 116 is snapped shut to hold the pocket square/handkerchief in place.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety. Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A pocket square/handkerchief holder, comprising:
a generally curved elongated holding member, said generally curved elongated holding member comprising a front surface and a back surface, said generally curved elongated holding member fixedly attached to a clipping device, said clipping device fixedly attached to a center portion of said back surface of said generally curved elongated holding member and retains and secures said folded pocket square/handkerchief against said back surface of said generally curved elongated holding member, said generally curved elongated holding member is placed within a person's shirt or outer breast pocket of a suit, sport or over coat to display said folded pocket square/handkerchief.

2. The pocket square/handkerchief holder of claim 1, further comprising a magnetic member, said magnetic member is fixedly attached to a top portion of said back surface of said generally curved elongated holding member and releasably attaches to other magnetic members.

3. The pocket square/handkerchief holder of claim 1, further comprising a clasp member, said clasp member is fixedly attached to a bottom portion of said back surface of said generally curved elongated holding member and holds folded money bills.
